(19) United States
(12) Patent Application Publication
(10) Pub. No.: US 2024/0198656 A1
(43) Pub. Date: Jun. 20, 2024

(54) CONVEYER APPARATUS FOR PELLET-SHAPED ARTICLES

(71) Applicant: ACKLEY MACHINE CORPORATION, Moorestown, NJ (US)

(72) Inventors: Jonathan Adam BRY, Cherry Hill, NJ (US); Bryan Edward RODILOSSO, Laurel Springs, NJ (US); Mark David FORD, Sicklerville, NJ (US)

(21) Appl. No.: 18/556,999

(22) PCT Filed: Apr. 22, 2022
(86) PCT No.: PCT/US2022/025888

§ 371 Date: Oct. 24, 2023

Related U.S. Application Data
(60) Provisional application No. 63/179,764, filed on Apr. 26, 2021.

(51) Int. Cl. B41F 17/36; B41F 33/00; G01N 21/84; G01N 21/95

(52) U.S. Cl. CPC B41F 17/36; B41F 33/0036; G01N 21/84; G01N 21/9508; G01N 2021/845

(57) ABSTRACT

Methods and apparatuses for identifying and averting exposed pellet-shaped article defects, deviations, and inclusions are disclosed. A vision system may be capable of identifying flaws/inclusions/defects/deviations affecting the exterior and/or interior of pellet-shaped articles via Ultra-Violet Light to instigate long-wave visible and Infra-red fluorescence. The UV Light and section of the visible spectrum not encompassing the instigated fluorescence may be removed with an optical filter so a camera can capture an image of discrete flaws/inclusions/defects/deviations. The vision system may send decision-signals to a mechanism to manipulate individual pellet-shaped articles. For example, a scam between halves of softgels may be rotated by an actuator having contact point(s) to hold a portion of the softgel stationary while a conveyer moves beneath causing rotation of the seam. This process may be performed prior to laser etching, printing, and/or drilling of pellet-shaped articles to reduce the number of pellet-shaped articles marked/printed/drilled on undesired surfaces.

### I. CROSS-REFERENCE TO RELATED APPLICATIONS

This application claims priority to U.S. Provisional Application No. 63/179,764, filed Apr. 26, 2021, the entire contents of which are incorporated herein by reference.

### II. FIELD OF THE TECHNOLOGY

The present technology relates to methods and apparatuses for identifying and averting exposed defects, deviations, and inclusions, transporting, inspecting, and processing pellet-shaped articles, e.g., tablets, caplets, lentil-shaped articles, etc.

### III. BACKGROUND OF THE TECHNOLOGY

Processing of pellet-shaped articles (e.g., softgel capsules, tablets, caplets, lentil-shaped articles, etc.), such as marking the articles with indicia, coloring the articles, laser drilling holes in the articles, coating the articles, and/or inspecting the articles is known in the art. The articles may be transported past one or more processing units (e.g., printing, inspection, drilling, rejection, etc.) by carrier links or carrier bars having article receiving pockets.

Softgel capsules are typically formed by bonding two halves of a gelatin-based shell together to encapsulate liquid contents, such as pharmaceuticals and confections. When consumed, the gelatin-based shell dissolves and the liquid contents are released. Bonding of the two halves of gelatin-based shell to produce softgel capsules forms a seam around the perimeter of the softgel capsule where the two halves meet. Softgel capsule production is sufficiently advanced that the softgel capsules typically do not have defects in either half after bonding, but the seam may be inconsistent, e.g., too thin, and therefore weak. After softgel capsules are produced, further processing, such as marking indicia on the softgel capsules with a laser and/or a printer, may be desired.

When a conveyer apparatus is used for such processing, e.g., lasering or printing, a hopper is loaded with a bulk quantity of softgel capsules that are each received and oriented randomly in pockets of carrier bars as they pass the hopper. Thus, the seam of each softgel capsule, once it enters the corresponding pocket, may be at any random position. The marking process, printing or lasering, is performed on the topmost exposed portion each of the softgel capsules as the carrier bars pass the processing unit. If the seam of any of the softgel capsules is positioned and exposed within this topmost region, the indicia may be printed or lasered on the seam. Because the seam may have an inconsistent structure once the softgel capsule is formed, the application of the indicia by printing or lasering may further weaken the seam, which could cause the softgel capsule to be more susceptible to premature rupture.

Weakening of the seam could cause an immediate problem to processing if a softgel capsule was to rupture while still in the conveyer apparatus because its contents could cause contamination, and prompt cleaning may be required. If the softgel capsule with a further weakened seam does not rupture while in the conveyer apparatus, subsequent operations, such as packaging or transport, could cause rupturing, which could contaminate nearby softgel capsules.

Furthermore, pellet-shaped article processing in fields such as pharmaceuticals and confections is maintained as an exacting art with increasing requirements of throughput bounded by physical limitations in its inability to discern flaws in processed pellet-shaped articles. Known methods of quality control require acceptance of an undesirably high proportion of lower-quality final product in which marking/drilling/printing processes are blindly fired on randomly indexed pellet-shaped articles. Processing operations that place undue pressure and forces on exposed flaws/inclusions/defects/deviations in the pellet-shaped articles have been catalogued as detrimental to integrity and function with statistically significant degradation in overall product quality. In addition to a pressing product-performance need, the marketable aesthetic nature of pharmaceutical and confectionary products is important to manufacturers and consumers so as to distinguish one's products from those of competitors. The indicia on pellet-shaped articles may also be critical for communicating criteria such as batch number and/or serialization to track the products along the way to the consumer. Compromising markings on the pellet-shaped articles by overlapping them with flaws/inclusions/defects/deviations may be detrimental to consumer safety, product function, and marketable aesthetics.

Furthermore, inspection technology has not advanced sufficiently to ensure that softgel capsules with marking-weakened seams can be rejected and removed from the system immediately after marking. Thus, the risk of contamination and associated losses of product has been accepted by producers.

Traditionally, imaging pellet-shaped articles with a camera that receives visible and/or infrared light reflected from the pellet-shaped articles (i.e., reflectance imaging) may not be capable of producing an image that allows for detection of defects and/or seams in various pellet-shaped articles (e.g., opaque, translucent, and/or specular surfaces, such as the shell of a softgel). For example, the image may include “hot spots” due to the complementary angle of incident light, specular surface, and the receiving sensor of the camera.

The present technology seeks to overcome the deficiencies of known conveyer and processing systems and reduce the risk of contamination and associated losses of product.

### IV. BRIEF SUMMARY OF THE TECHNOLOGY

An aspect of the present technology is directed to an apparatus for processing and/or inspecting pellet-shaped articles. The apparatus may include a conveyer for transporting the pellet-shaped articles past one or more units that process and/or inspect the pellet-shaped articles.

An aspect of the present technology is directed to an apparatus for processing pellet-shaped articles, each of the pellet-shaped articles having a seam around its perimeter, the apparatus comprising: a conveyer comprising a plurality of carrier bars, each of the carrier bars having a plurality of pockets; an inspection unit; a plurality of article contacting devices, each of the article contacting devices being configured to contact a corresponding one of the pellet-shaped articles passing thereby; a processing unit configured to mark each of the pellet-shaped articles; and a controller configured to: determine whether the seam of each of the pellet-shaped articles is positioned inside or outside of a predetermined boundary; and responsive to the determination, instruct the article contacting device whether to manipulate the pellet-shaped article.

Another aspect of the present technology is directed to an apparatus for processing pellet-shaped articles, each of the pellet-shaped articles having a seam around its perimeter, the apparatus comprising: a conveyer comprising a plurality of carrier bars, each of the carrier bars having a plurality of pockets arranged in a row that is oriented perpendicularly to a direction of travel of the carrier bars along a conveyer path, each of the pockets being configured to receive one of the pellet-shaped articles; an inspection unit configured to acquire an image of each of the pellet-shaped articles; a plurality of article contacting devices positioned downstream of the inspection unit along the conveyer path and arranged in a row that is oriented perpendicularly to the direction of travel of the carrier bars, a number of article contacting devices being equal to a number of pockets in each of the carrier bars, and each of the article contacting devices being configured to contact a corresponding one of the pellet-shaped articles passing thereby along the conveyer path while being held in a corresponding pocket; a processing unit positioned downstream of the plurality of article contacting devices and configured to mark each of the pellet-shaped articles; and a controller configured to: receive the image of each of the pellet-shaped articles acquired by the inspection unit; determine, based on the image, whether the seam of each of the pellet-shaped articles is positioned inside or outside of a predetermined boundary; and responsive to the determination, instruct the article contacting device whether to manipulate the pellet-shaped article.

In examples of any aspect of the two preceding paragraphs: (a) the controller may be configured to instruct the article contacting device corresponding to the pocket holding the pellet-shaped article having the seam positioned inside of the predetermined boundary to contact that pellet-shaped article while passing that article contacting device, if the seam of any one of the pellet-shaped articles is determined to be positioned inside of the predetermined boundary, (b) the controller may be configured to allow the pellet-shaped article having the seam positioned outside of the predetermined boundary to pass the corresponding article contacting device without contact, if the seam of any one of the pellet-shaped articles is determined to be positioned outside of the predetermined boundary, (c) each of the article contacting devices may comprise an actuator and a finger connected to the actuator, (d) the finger of each of the article contacting devices may comprise a contacting portion configured to contact each of the pellet-shaped articles, (e) the contacting portion comprises a flexible material, (f) the flexible material may be rubber, (g) the contacting portion may be a rubber O-ring, (h) the finger may have an elongate shape, a first end of the finger being connected to the actuator and the contacting portion being positioned on a second end of the finger, (i) the actuator may be configured to move the finger towards and away from the conveyer along a longitudinal axis of the finger, (j) the actuator may be a solenoid, (k) the actuator may be pneumatically operated, (l) each of the article contacting devices may comprise a spring to attenuate motion of the finger when the contacting portion contacts a corresponding pellet-shaped article, (m) each of the article contacting devices may be configured to contact, when instructed by the controller, a corresponding pellet-shaped article for a duration sufficient to rotate the pellet-shaped article approximately 90° within the corresponding pocket, (n) each of the pockets may be shaped and dimensioned to allow the pellet-shaped article held therein to rotate when contacted by the corresponding article contacting device, (o) each of the carrier bars may be coated, at least inside each of the pockets, with a substance to reduce friction with the corresponding pellet-shaped article, (p) at least the pockets of each of the carrier bars may be formed from a material that reduces friction with the corresponding pellet-shaped article, (q) the processing unit may comprise at least one of a laser and a printer, (r) the inspection unit may comprise a camera or a near-infrared (NIR) sensor, (s) an additional inspection unit may be positioned downstream of the processing unit and configured to acquire an additional image of each of the pellet-shaped articles after processing, (t) an ejection system may be configured to direct each of the pellet-shaped articles into an accept bin or a reject bin, and/or (u) the controller may be configured to: receive the additional image of each of the pellet-shaped articles acquired by the additional inspection unit; determine, based on the image, whether the seam and the indicia of each of the pellet-shaped articles is inside or outside of the predetermined boundary; if the seam and the indicia of any one of the pellet-shaped articles are positioned inside of the predetermined boundary, then instruct the ejection system to direct the corresponding pellet-shaped article into the reject bin; and if the seam of any one of the pellet-shaped articles is positioned outside of the predetermined boundary and the indicia of any one of the pellet-shaped articles is positioned inside of the predetermined boundary, then instruct the ejection system to direct the corresponding pellet-shaped article into the accept bin.

Another aspect of the present technology is directed to a system for inspecting pellet-shaped articles. The system may comprise: a conveyer including a plurality of carrier bars configured to transport pellet-shaped articles, each of the carrier bars having one or more pockets shaped and dimensioned to receive one pellet-shaped article; one or more inspection apparatuses including: a light source configured to illuminate the pellet-shaped articles with light; a camera configured to capture an image of each of the pellet-shaped articles; and a filter configured to restrict transmission of light having a wavelength approximately equal to the light from the light source, the filter being positioned between the pellet-shaped articles and the camera such that light having a wavelength approximately equal to the light from the light source is prevented from reaching the camera.

Another aspect of the present technology is directed to a system for inspecting and processing pellet-shaped articles. The system may comprise: a conveyer including a plurality of carrier bars configured to transport pellet-shaped articles along a conveyer path, each of the carrier bars having one or more pockets, and each of the pockets being shaped and dimensioned to receive one pellet-shaped article; one or more inspection apparatuses, the conveyer being configured to transport the pellet-shaped articles past the inspection apparatus, the inspection apparatus including: a light source configured to illuminate the pellet-shaped articles with light while passing the inspection apparatus; a camera configured to capture an image of each of the pellet-shaped articles while passing the inspection apparatus; and a filter configured to restrict transmission of light having a wavelength approximately equal to the light from the light source, the filter being positioned between the pellet-shaped articles passing through the inspection apparatus and the camera such that light having a wavelength approximately equal to the light from the light source is prevented from reaching the camera; one or more processing apparatuses configured to perform one or more processing operations on the pellet-shaped articles; and a controller configured to receive images of the pellet-shaped articles captured by the camera and configured to instruct the one or more processing apparatuses to perform the one or more processing operations.

In examples of any aspect of the two preceding paragraphs: (a) light from the light source may be UV light, (b) light from the light source may have a wavelength centered at a wavelength in the range of approximately 300 nm to approximately 800 nm, (c) light from the light source may have a wavelength centered at approximately 365 nm, (d) the filter may be configured to transmit only visible light, (e) the filter may be configured to transmit only light having a wavelength within a portion of the visible light spectrum, (f) the filter may be an absorption filter, (g) the controller may be configured to detect one or more characteristics of each of the pellet-shaped articles from each image received from the camera, (h) the pellet-shaped articles may be softgel capsules and the characteristic is a seam each of the softgel capsules, (i) a hole may extend from each pocket through each of the carrier bars, (j) each of the carrier bars may include a number of holes equal to a number of pockets, (k) the hole may extend from a bottom surface of pocket, (l) a vacuum generator may be pneumatically connected to a conveyer base to draw a vacuum through each hole in the carrier bars passing over the conveyer base, (m) the carrier bars may comprise a base constructed from a first material and a pocket insert constructed from a second material that is different from the first material, (n) the pockets may be formed in the pocket insert, (o) the first material may be more rigid than the second material, (p) the first material may be metal and the second material may be plastic, (q) the metal may be aluminum, (r) the hole may extend through the first material and the second material, (s) the pocket insert may be removable from the base, (t) the system may comprise a first inspection apparatus and a second inspection apparatus; and a first processing apparatus positioned downstream of the first inspection apparatus and upstream of the second inspection apparatus relative to the conveyer path and a second processing apparatus downstream of the second inspection apparatus relative to the conveyer path, (u) the processing apparatus may comprise an article contacting device positioned above each row of pockets of the carrier bars, the article contacting device being configured to contact individual pellet-shaped articles in response to instructions from the controller to rotate individual pellet-shaped articles within respective pockets, (v) each article contacting device may comprise an actuator, a finger configured to driven by the actuator, and a contacting portion movably connected to the finger, the contacting portion configured to contact individual pellet-shaped articles in corresponding pockets, (w) the contacting portion may comprise a base having one or more wheels immovably fixed thereto and an O-ring positioned around each wheel to contact pellet-shaped articles, (x) the article contacting device may comprise a pivot pin that pivotably connects the finger to the base of the contacting portion and a spring positioned between the finger and the base to bias the contacting portion, and/or (y) a processing unit may be configured to apply a mark to each of the pellet-shaped articles.

Another aspect of the present technology is directed to a carrier bar for transporting pellet-shaped articles in a conveyer apparatus. The carrier bar may comprise: a base constructed from a first material; a pocket insert constructed from a second material that is different from the first material; one or more pockets formed in the pocket insert and each of the pockets being shaped and dimensioned to receive a single pellet-shaped article; and a hole extending from each pocket through the pocket insert and the base.

In examples of the aspect in the preceding paragraph: (a) the first material may be more rigid than the second material, (b) the first material may be metal and the second material may be plastic, (c) the metal may be aluminum, (d) the pocket insert may be removable from the base, (e) the pocket insert may comprise one or more internally threaded receiving members, each forming a blind bore that terminates within the pocket insert, (f) the base may comprise one or more through holes corresponding in number to the internally threaded receiving members, one of the internally threaded receiving members extending into a corresponding one of the through holes, (g) the carrier bar may comprise one or more bolts corresponding in number to the internally threaded receiving members and the through holes, each of the bolts extending through a corresponding one of the through holes and into a corresponding one of the internally threaded receiving members to secure the base and the pocket insert together, and/or (h) each of the through holes may be counterbored to receive a bolt head of the corresponding bolt so that the bolt head is recessed from the bottom of the base.

Of course, portions of the aspects may form sub-aspects of the present technology. Also, various ones of the sub-aspects and/or aspects may be combined in various manners and also constitute additional aspects or sub-aspects of the present technology.

### V. BRIEF DESCRIPTION OF THE DRAWINGS

The accompanying drawings facilitate an understanding of the various examples of this technology. In such drawings:

FIG. 1 is a perspective view of a conveyer apparatus, including processing and ejection units.

FIG. 2 is a schematic of a conveyer apparatus according to an example of the present technology.

FIG. 3 is a top view of a carrier bar with pellet-shaped articles held in pockets according to an example of the present technology.

FIG. 4 is another top view of a carrier bar with pellet-shaped articles held in pockets according to an example of the present technology.

FIG. 5 is an elevation view of an article contacting device according to an example of the present technology.

FIG. 6 is an elevation view of an inspection unit according to an example of the present technology.

FIG. 7 is a perspective view of an inspection unit according to an example of the present technology.

FIG. 8 is an elevation view of a processing unit and a vacuum unit according to an example of the present technology.

FIG. 9 is a perspective view of a processing unit according to an example of the present technology.

FIG. 10 is a detailed perspective view of a processing unit according to an example of the present technology.

FIG. 11 is an elevation view of a processing unit according to an example of the present technology.

FIG. 12 is another elevation view of a processing unit according to an example of the present technology.

FIG. 13 is a perspective view of a carrier bar according to an example of the present technology.

FIG. 14 is another perspective view of a carrier bar according to an example of the present technology.

FIG. 15 is an exploded view of a carrier bar according to an example of the present technology.

FIG. 16 is a cross-sectional view of a carrier bar according to an example of the present technology taken through line 16-16 of FIG. 13.

FIG. 17 is a cross-sectional view of a carrier bar according to an example of the present technology taken through line 17-17 of FIG. 13.

FIG. 18 is a flow chart of the operation of a conveyer apparatus according to an example of the present technology.

### VI. DETAILED DESCRIPTION OF THE TECHNOLOGY

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to various examples which may share one or more common characteristics and/or features. It is to be understood that one or more features of any one example may be combinable with one or more features of another example or other examples. In addition, any single feature or combination of features in any of the examples may constitute a further example.

### A. Conveyer Apparatus

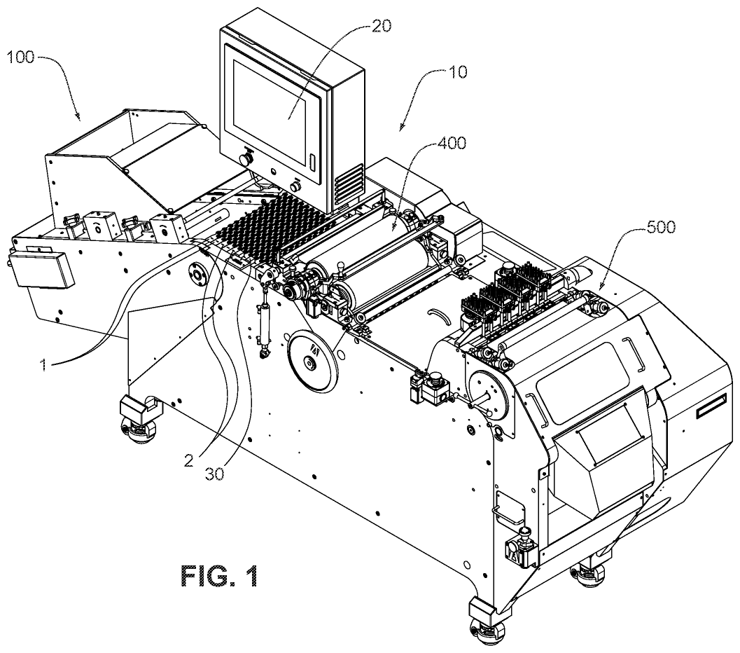

The conveyer apparatus 10 of FIG. 1 may be used for processing, e.g., lasering or printing, pellet-shaped articles 3, e.g., softgel capsules. The conveyer apparatus 10 may include a hopper 100, a user interface 20 for receiving input and displaying information related to control of the system, and a conveyer 30 with a series of carrier bars 1, each having a plurality of pockets 2 formed in a row. The conveyer apparatus 10 also may include a processing unit 400, e.g., in the form of a laser or a printer for marking indicia. The conveyer apparatus also may include an ejection system 500 for removing pellet-shaped articles 3 from the conveyer 30 and segregating them based on whether they are acceptable or not.

The hopper 100 may be loaded with a bulk quantity of pellet-shaped articles 3 that may each be received and oriented randomly in individual pockets 2 of the carrier bars 1 as they pass the hopper 100. Thus, the seam of each of the pellet-shaped articles 3, once it enters the corresponding pocket 2, may be at any random position. The marking process, printing or lasering, is performed on the topmost exposed portion each of the pellet-shaped articles 3 as the carrier bars 1 pass the processing unit 400.

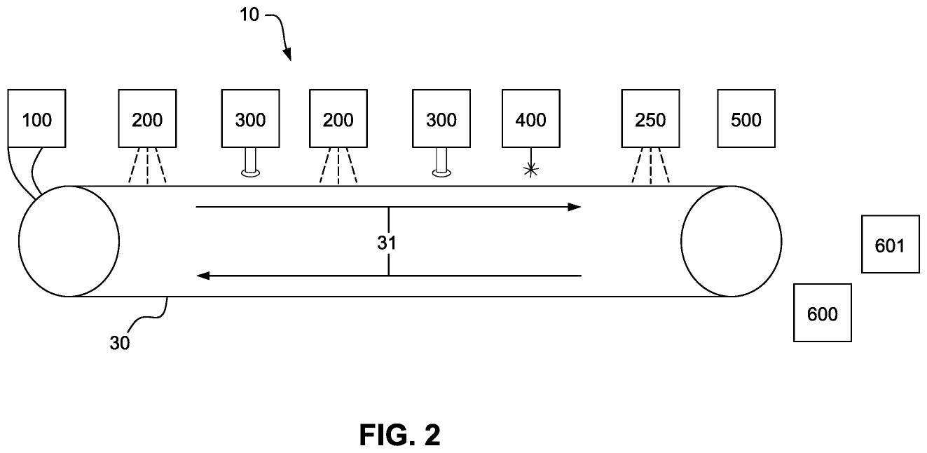

FIG. 2 shows a schematic of conveyer apparatus 10 according to an example of the present technology, and any one or more of its components, as described below, may be included in the apparatus 10 of FIG. 1.

The apparatus 10 may include a conveyer 30 that transports the pellet-shaped articles 3 along a conveyer path 31. The conveyer 30 may also include carrier bars 1, each having a plurality of pockets 2 to transport individual pellet-shaped articles 3 along the conveyer path 31. Also, the carrier bars 1 may be driven by a conveyer motor (not shown). It should be understood, however, that alternative examples of the technology may include carrier bars 1 or carrier links, each having a single pocket 2 such that each carrier link is able to transport only one pellet-shaped article 3.

The pellet-shaped articles 3 may be fed onto the conveyer 30 by a hopper 100, which may be designed to hold a large number of pellet-shaped articles 3 supplied thereto in bulk. As the carrier bars 1 of the conveyer 30 pass the hopper 100, pellet-shaped articles 3 may be taken into pockets 2 of the carrier bars 1 for inspecting and processing by the apparatus 10.

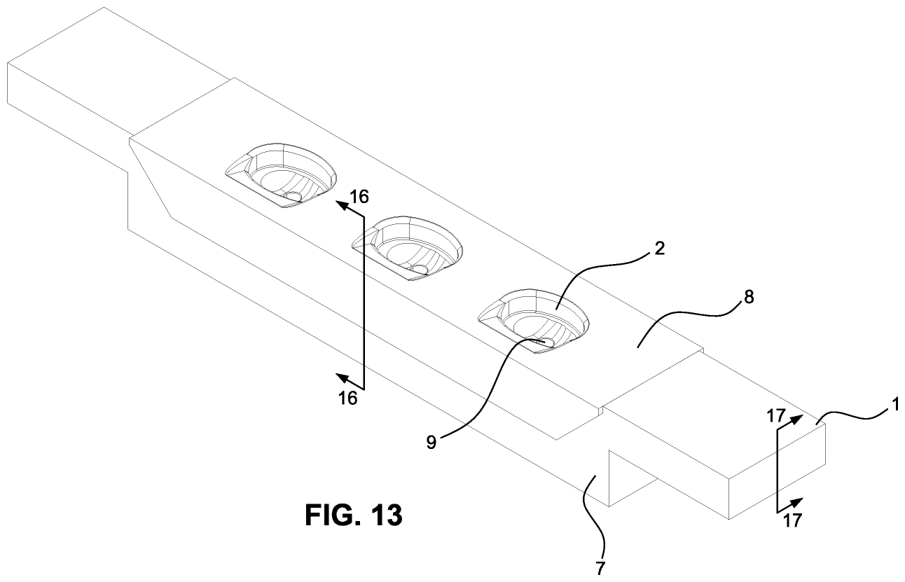

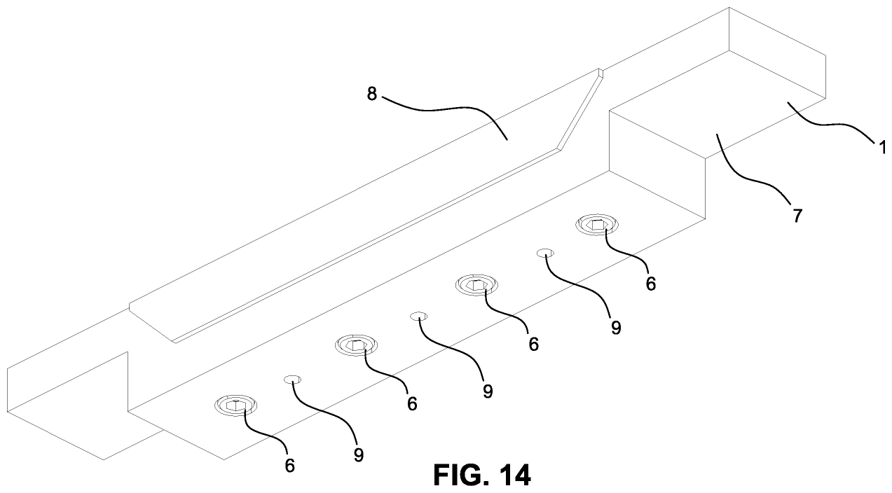

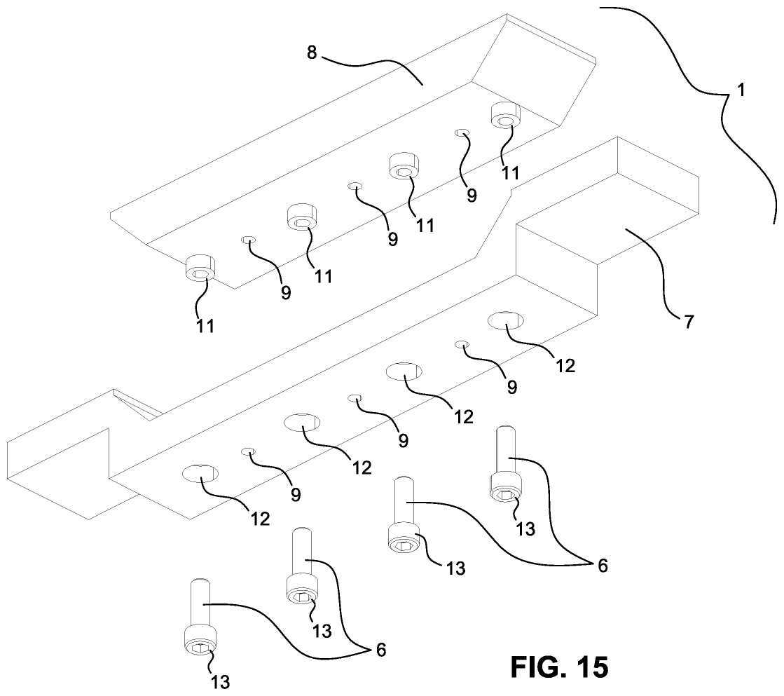

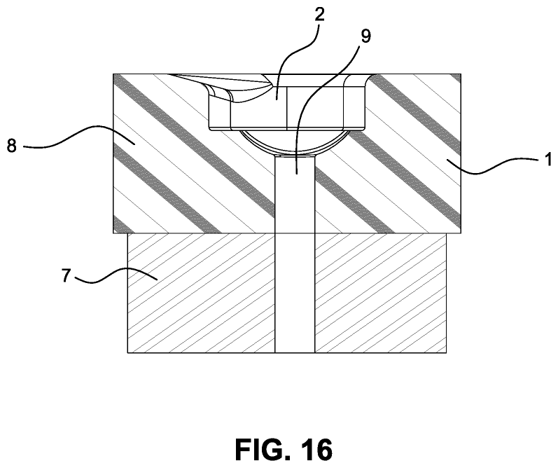

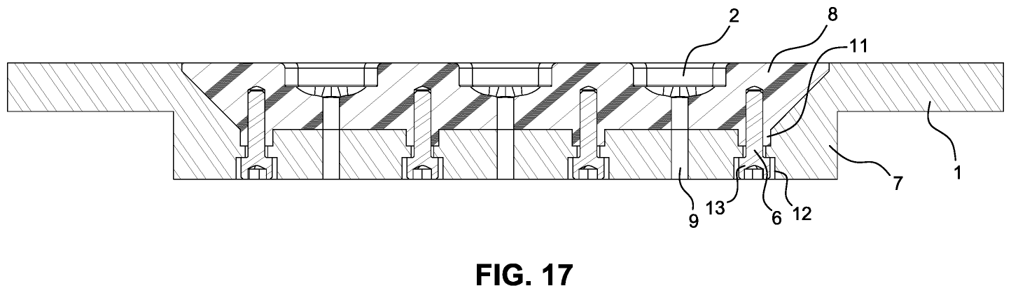

FIGS. 13-17 show an example of the carrier bar 1 of the present technology. The carrier bar 1 may be a multi-part structure including a base 7 and a pocket insert 8. The pockets 2 may be formed in the pocket insert 8, which is attached, removably or permanently, to the base 7. The base 7 may be constructed from a material that is more rigid than a material of the pocket insert 8. The base 7 may be constructed from metal, such as aluminum. The pocket insert 8 may be constructed from a polymer, such as plastic. Polymers such as plastic may be beneficial for the present examples because they reflect less light, and therefore are less likely to obscure the image capture. Alternatively, the carrier bar 1 may be formed from a single piece of homogeneous material, which may be relatively rigid. The relatively rigid material may be metal, such as aluminum.

The carrier bar 1 may also include a hole 9 corresponding to each pocket 2 that extends through the carrier bar 1 from each pocket 2. Where the carrier bar 1 is constructed from the base 7 and the pocket insert 8, the hole 9 may extend continuously and coaxially through the base 7 and the pocket insert 8, if present, or continuously through the carrier bar 1 if it is formed in one piece. As described elsewhere herein, the hole(s) 9 may allow a vacuum to be drawn against a pellet-shaped article 3 in the corresponding pocket 2.

Furthermore, where the carrier bar 1 is constructed from the base 7 and the pocket insert 8, one or more bolts 6 may secure the base 7 and the pocket insert 8 together. As shown in the depicted example, the bolts 6 are inserted through the base 7 first and then into the pocket insert 8 from the bottom of the carrier bar 1. The pocket insert 8 may include one or more internally threaded receiving members 11 to threadedly receive the respective bolt 6, which may be externally threaded. The receiving members 11 may form blind bores that terminate within the thickness of the pocket insert 8, such that the bores do not reach or pass through the top of the pocket insert 8, leaving the top surface smooth (with the exception of the pockets 2). In other words, the bolts 6 are exposed opposite the pockets 2 so as to avoid the risk of interference with inspecting and processing operations. The receiving members 11 may protrude downward and are dimensioned to fit within one or more corresponding through holes 12 in the base 7. The through holes 12 may also be counterbored opposite the pocket insert 7 to receive a bolt head 13 of the corresponding bolt 6. This allows the bolt 6 to be recessed from the bottom of the carrier bar 1 and not interfere with movement of the carrier bars 1 along the conveyer path 31 by contact with other structures such as the conveyer base 32. Furthermore, the protruding receiving members 11 fit into the through holes 12 such that the vacuum holes 9 are automatically aligned when the base 7 and the pocket insert 8 are assembled.

### B. Inspecting Pellet-Shaped Articles

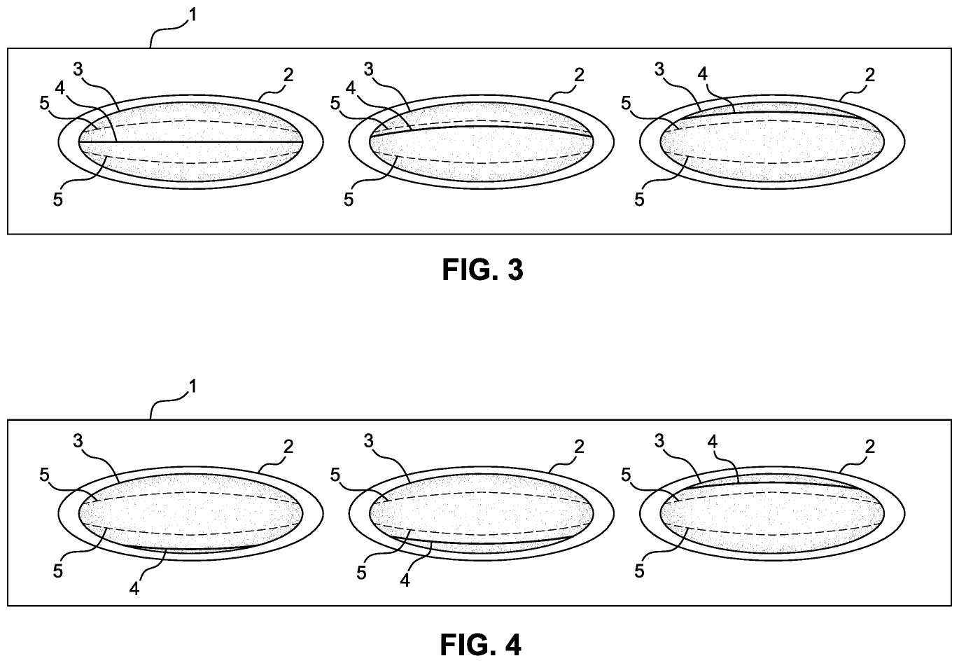

FIG. 3 shows an example of a carrier bar 1 with pockets 2, each holding one pellet-shaped article 3, e.g., softgel capsules, and a seam 4 of each pellet-shaped article 3, in a different position. Since the pellet-shaped articles 3, softgel capsules in these examples, may be round (spherical or ellipsoidal) and may be formed from two identical halves, each could have its seam 4 oriented at any position about its longitudinal axis. Also, since the seam 4 extends 360° around the perimeter of the pellet-shaped article 3, it is possible that part of each seam 4 will be visible from above. If the seam 4 of any of the pellet-shaped articles 3 is determined to be inside of a predetermined boundary 5, then those pellet-shaped articles 3 may be repositioned, e.g., by rotation, before marking, as will be described below.

FIG. 3 shows the pellet-shaped article 3 on the left having its seam 4 positioned approximately directly over the longitudinal axis of the pellet-shaped article 3 and inside of the predetermined boundary 5. The middle pellet-shaped article 3 in FIG. 3 is not positioned directly over the longitudinal axis of the pellet-shaped article 3 but the seam 4 is still inside of the predetermined boundary 5. The pellet-shaped article 3 on the right of FIG. 3 has its seam 4 positioned outside of the predetermined boundary 5. Since the dimensions of the predetermined boundary 5 may be calculated based on the size of the indicia to be applied to the pellet-shaped articles 3, the seam 4 should be moved out of the predetermined boundary 5 before marking of any applicable pellet-shaped articles 3 to avoid having the indicia applied to the seam 4, possibly damaging it.

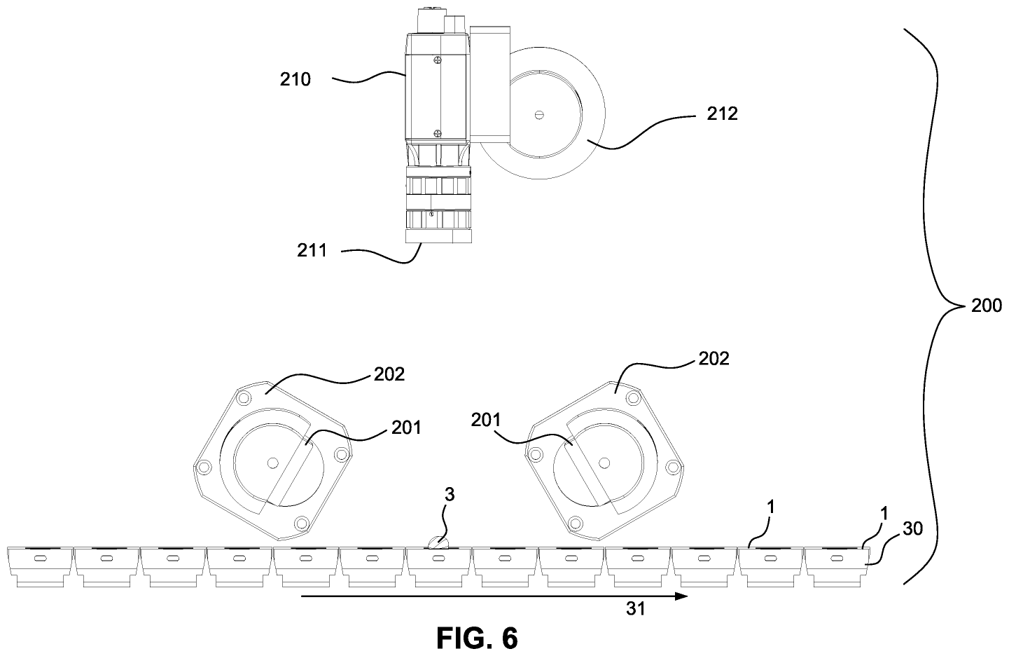

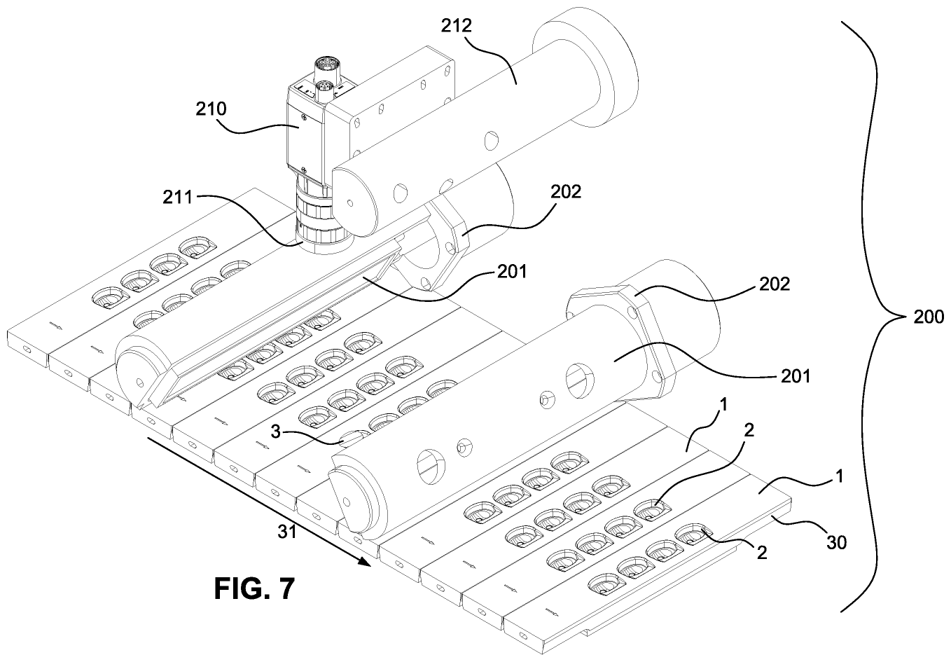

As the carrier bars 1, with one pellet-shaped article 3 in each pocket 2, reach an inspection unit 200, the inspection unit 200 may acquire an image of each pellet-shaped article 3 and transmit the images to a controller (not shown). FIGS. 6 and 7 show examples of the inspection unit 200, which may include a camera 210 (e.g., CCD or CMOS) and/or a near-infrared (NIR) sensor. The camera 210 may have a spectral sensitivity of approximately 400 nm to approximately 700 nm, and in further examples the range of spectral sensitivity may be greater. The controller may include processing resources (e.g., CPU, memory, storage, etc.) to perform image processing and control functions. The controller may analyze each image captured by the camera 210 and determine whether the seam 4 detected in each image is inside or outside of the predetermined boundary 5. The dimensions of the predetermined boundary 5 may be calculated based on the known size and shape of the pellet-shaped articles 3 and the indicia intended to be marked thereon.

FIGS. 6 and 7 show an example the inspection unit 200. The inspection unit 200 may include one or more light sources 201. The light source(s) 201 may be positioned above the conveyer 30 to illuminate the pellet-shaped articles 3 as they pass through the inspection unit 200. In this example, two light sources are shown to illuminate front and rear side of the pellet-shaped articles 3, but one light source 201 may be adequate if it is positioned so as to illuminate the portion of the pellet-shaped article 3 exposed in the pocket 2. For example, a single ring light may be used as the light source 201 and may be mounted on the camera 210 to illuminate the pellet-shaped articles 3. Each light source 201 may be joined to the conveyer apparatus 10 with a light source mount 202. Each light source 201 may generate monochromatic light or polychromatic light. If the generated light is monochromatic, it may be centered on a wavelength from approximately 300 nm to approximately 800 nm. In a further example, the monochromatic light may be centered at a wavelength of 365 nm. Additionally, by using monochromatic light, as opposed to polychromatic light, the light source(s) 201 may be optimally efficient in that the entire intensity of the light generated is focused only on the band that will caused the desired fluorescence of pellet-shaped articles 3, e.g., softgels, as described below. Furthermore, monochromatic light may also simplify selection of the filter because it may be sufficient to only filter out the light generated by the light source(s) 201 for the image capture and analysis described below.

The inspection unit 200 also includes the camera 210. The camera 210 may be positioned above the conveyer 30 to capture an image of each of the pellet-shaped articles 3 as they pass the inspection unit 200. A filter 211 may also be positioned above the conveyer 30 to filter light before reaching the camera 210. The filter 211 may be mounted on the camera 210 or it may be positioned below the camera 210 but still in a location to filter light before reaching the camera 210. The camera 210 may be mounted to the conveyer apparatus 10 by a camera mount 212. Fasteners (not shown) may connect the light source mount 202 and the camera mount 212 to the conveyer apparatus 10.

In the depicted example, each of the pellet-shaped articles 3 may be subjected to direct, low-angle, Ultra-Violet (UV) light from the light source(s) 201 while underneath the camera 210. Pellet-shaped articles 3 such as softgels, specifically the shell, may fluoresce when subjected to UV light. The longer wavelength light emitted from the pellet-shaped articles 3, e.g., softgels, may then be detected by the camera 210 to capture an image of each of the pellet-shaped articles 3. Pellet-shaped articles 3 have an outer surface (a gelatin-based shell in the case of softgels), the specific recipe of which may vary, and that outer surface may be capable of auto-fluorescence. In softgels for example, the gelatin-based shell may be auto-fluorescent. In other words, the fluorescent effect may be inherent to the chemical compounds in the outer surface of the pellet-shaped articles 3, i.e., the gelatin-based shell in the case of softgels). In further examples, the outer surface of the pellet-shaped articles 3 (again, a gelatin-based shell in the case of softgels) may include a fluorophore additive, which is based on a chemical compound known to fluoresce in response to incident light at a known wavelength. Whether the pellet-shaped articles 3 are auto-fluorescent, include a fluorophore additive, or both, they may be caused to fluoresce by excitation with light having a predetermined wavelength.

The filter 211 may be used to block transmission of the UV light generated by the light source(s) 201 so as not to interfere with the image captured and so that the image transmitted to the controller for detection of the seam 4 and/or defects is adequately clear and precise. The filter 211 may be an absorption filter that absorbs light that is to be prevented from reaching the camera 210, UV light in the present example. The filter 211 may be a bandpass, longpass, or dual-bandpass filter having sufficient optical density to completely or nearly completely block transmission of the UV light. The optical density may also be sufficient to block transmission of any portion of light in the visible spectrum that is outside of the spectrum of light emitted by the fluorescing pellet-shaped articles 3. Thus, by preventing selected bands of light from reaching the camera 210 the fluoresced bands of light are maximally exposed to the camera 210, thereby saturating the camera's 210 sensor with only long-wave visible light and/or infrared light.

The inherent properties of long-wave visible light and/or infrared light allow the camera 210 and the controller to discern interior and exterior features, such as the seam 4 and its position and various defects, of the pellet-shaped articles 3 that may otherwise be obscured by difficult-to-image opaque, translucent, and/or specular surfaces, such as the shell of a softgel. For example, the seam 4 of each of the softgel pellet-shaped articles 3 in FIGS. 3 and 4 might not be easily detectable from light across a broad range of the visible light spectrum. Indeed, that may be intentional so as to provide a clean, seamless aesthetic of the product for the consumer. However, by fluorescing the pellet-shaped articles 3 the seams 4 may be more easily detectable when the camera's 210 image sensor is saturated with light emitted from the pellet-shaped articles 3 at a narrow wavelength band and high intensity.

In an example, the light source(s) 201 directs UV light centered at a wavelength of 365 nm at the pellet-shaped articles 3, e.g., softgels, as they pass through the inspection unit 200. The UV light may cause the pellet-shaped articles 3 to fluoresce, i.e., emit light at a higher, visible wavelength while absorbing the UV light, at a wavelength of 730 nm. A filter 211 is selected that permits transmission of light centered at the fluorescing wavelength (730 nm) along with some tolerance for light slightly above and below the center wavelength (+5% or +10%), while blocking, e.g., by absorption, the exciting, UV light centered at 365 nm to prevent the UV light reflected from other conveyer apparatus 10 components from interfering with image capture. The light at 730 nm that results from fluorescence of the pellet-shaped articles 3 therefore saturates the camera's 210 image sensor to provide the controller with sufficient data for image processing and subsequent control operations of other components.

In yet another example, light from the light source(s) 201 centered at 355 nm may be used for excitation.

In a further example, the filter 211 may be selected to only permit transmission of light at the fluorescing wavelength while blocking all other light.

In a still further example, the exciting light from the light source 201 may be centered at a wavelength in the visible, rather than UV, spectrum, so long as it causes fluorescence of the pellet-shaped articles 3.

The following chart describes further examples of exciting light from the light source(s) 201 and corresponding emitted light from the pellet-shaped articles 3 that is permitted to pass through the filter 211 for image capture by the camera 210, where UV=Ultra-Violet, VIS=visible, NIR=Near Infra-Red, and IR=Infra-Red. In examples, the type of light described as being permitted to pass through the filter 211 in a given example may be the only light permitted to pass through the filter 211. In still further examples, the filter 211 may be a dual bandpass filter that allows light of the indicated wavelength band to pass as a first band, as well as a harmonic of light of the indicated wavelength band to pass as a second band. For example, light centered at 700 nm may be the first band and light centered at 1400 nm may be the second band.

| Exciting light from | Light passed through |
|---|---|
| light source(s) 201 | filter 211 |
| Monochromatic UV Light | portion of UV spectrum allowed through |
| | filter (not overlapping the light source |
| | wavelength) |
| Monochromatic UV Light | portion of VIS spectrum allowed through |
| | filter |
| Monochromatic UV Light | portion of NIR/IR spectrum allowed |
| | through filter |
| Monochromatic VIS Light | portion of VIS spectrum allowed through |
| | filter (not overlapping the light source |
| | wavelength) |
| Monochromatic VIS Light | portion of NIR/IR spectrum allowed |
| | through filter |
| Monochromatic NIR/IR Light | portion of NIR/IR spectrum allowed |
| | through filter (not overlapping the light |
| | source wavelength) |
| Polychromatic UV Light | portion of VIS spectrum allowed through |
| | filter |
| Polychromatic UV Light | portion of NIR/IR spectrum allowed |
| | through filter |
| Polychromatic VIS Light | portion of NIR/IR spectrum allowed |
| | through filter |

In another example, the exciting light from the light source 201 may be centered at a wavelength that causes the pellet-shaped articles 3 to fluoresce at a wavelength in the infrared spectrum, rather than at a wavelength in the visible spectrum as in the above example. In this example, the camera 210 would be selected to have a spectral sensitivity that includes the fluorescing wavelength centered in the infrared spectrum.

The fluorescing effect may also be beneficial for opaque softgel shells which are not transparent to visible, but may be transparent to light at the fluoresced wavelength. This may allow interior features such as fill level and interior shell defects to be detected when such defects otherwise might not be detectable by visible light alone.

The inspection units 200, 250 may also include a system to allow different filters 211 to be swapped in front of the camera 210 depending on the pellet-shaped articles 3 being inspected. With a given exciting light from the light source(s) 201, different pellet-shaped articles 3 may fluoresce at different wavelengths, e.g., due to different compounds in the outer surface or the shell in the case of softgels. Accordingly, the conveyer apparatus 10 may be equipped a device to readily change the filter 211 to one that permits light transmission at the known fluorescing wavelength of a given type of pellet-shaped articles 3.

The inspection units 200, 250 may be used to detect defects in pellet-shaped articles 3 instead of or in addition to the seam 4. If a defective pellet-shaped article 3 is detected, the defective pellet-shaped article 3 may continue along the conveyer 30 without being subjected to any repositioning and/or processing steps such as those described below. Defective pellet-shaped articles 3 may be directed into a reject bin 601 by an ejection system 500. Defects that may be detected include but are not limited to spots, holes, chips, dents, cracks, bumps, and stains on the outer surface of the pellet-shaped article 3, seam 4 defects, pellet-shaped articles 3 that are not within a predetermined tolerance for size and/or shape, and/or empty or underfilled pellet-shaped articles 3. The inspection unit 200 may also be able to detect and determine whether pellet-shaped articles 3 are properly seated in respective pockets 2. If a given pellet-shaped article 3 is determined to be oriented improperly within its pocket 2, the manipulation and/or processing steps of the article contacting device 300 and/or the processing unit 400 may be omitted to avoid damaging the pellet-shaped article 3. The post-processing inspection unit 250 may also detect defects such as flaws in the mark applied by the processing unit 400. The controller may assess the severity of any such defects detected in the captured image and then instruct the ejection system 500 to direct any pellet-shaped articles 3 exhibiting sufficiently severe defect(s).

It should also be understood that the conveyer apparatus 10 may include only the inspection unit 200, which would be used to detect the defects described above, but no further device for manipulation and processing such as the article contacting device 300 and the processing unit 400. In other words, conveyer apparatus 10 would be an inspection-only system. Any defective pellet-shaped articles 3 identified would then be directed into the reject bin 601 by the ejection system 500 while acceptable pellet-shaped articles 3 would be directed into the accept bin 600 by the ejection system 500.

### C. Repositioning Pellet-Shaped Articles

FIG. 4 shows the same carrier bar 1, pockets 2, and pellet-shaped articles 3 of FIG. 3, but the left and center pellet-shaped articles 3 have been rotated within respective pockets 2 so that the respective seams 4 are no longer positioned inside of the respective predetermined boundaries 5. The pellet-shaped article 3 on the right was not rotated and its seam 4 remains in the same position as in FIG. 3 because its seam 4 was already outside of the predetermined boundary 5. In the example of FIG. 2, where there are two inspection units 200, FIG. 3 may be an image taken from the upstream inspection unit and FIG. 4 may be an image taken from the downstream inspection unit 200.

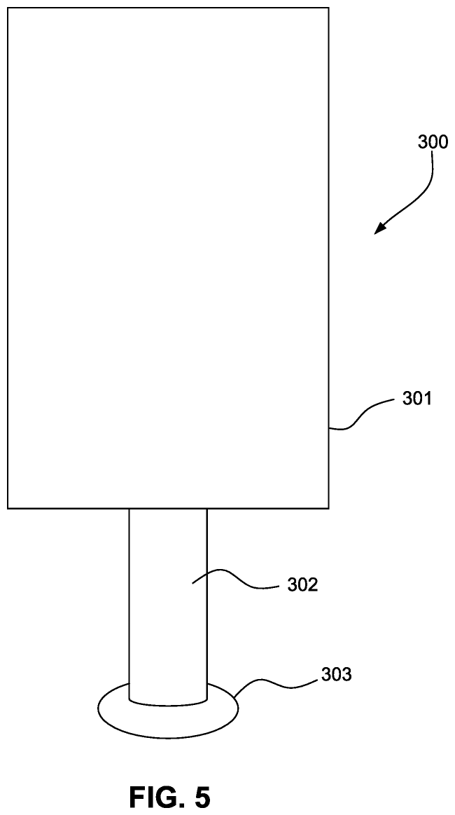

Manipulation, repositioning, or rotation of applicable pellet-shaped articles 3 may be performed by an article contacting device 300, an example of which is shown in FIG. 5. The apparatus 10 may be equipped with a number of article contacting devices 300 equal to the number of pockets 2 in each carrier bar 1. The rows of each may be oriented transverse to the conveyer path 31. Each article contacting device 300 may include an actuator 301 having a finger 302 movably connected thereto and a contacting portion 303 positioned on the finger 302. Each finger 302 may have an elongate shape, a first end of the finger being connected to the actuator 301 and the contacting portion 303 being positioned on a second end of the finger 302.

Each contacting portion 303, since during operation it will contact the pellet-shaped articles 3, which may be supple in the case of softgel capsules, may be formed from a flexible material to minimize the risk of damaging the pellet-shaped articles 3 upon contact. The flexible material may be rubber. In an example, the contacting portion 303 may be a rubber O-ring.

The actuator 301 may be configured to move the finger 302 towards and away from the conveyer 30 along a longitudinal axis of the finger 302. The actuator 301 may be a solenoid or it may be pneumatically operated.

Each of the article contacting devices 300 may include a spring (not shown), e.g., where the finger 302 connects to the actuator 301 and/or to the contacting portion 303. The spring may attenuate motion of the contacting portion 303 when the contacting portion 303 contacts a corresponding pellet-shaped article 3 to further avoid potential damage to the pellet-shaped articles 3.

As noted above, FIG. 2 shows an example of the apparatus 10 of the present technology that includes one or more article contacting devices 300 for rotating the pellet-shaped articles 3, as desired, prior to reaching the processing unit 400. As individual pellet-shaped articles 3 are each taken up into respective pockets 2 of the carrier bars 1 while passing the hopper 100, the pellet-shaped articles 3 may be positioned in any orientation about their respective longitudinal axes, as explained with respect to FIG. 3—some pellet-shaped articles 3 may have their seam 4 positioned inside of the predetermined boundary and some pellet-shaped articles 3 may have their seam 4 positioned outside of the predetermined boundary.

If the controller determines that the seam 4 of any one of the pellet-shaped articles 3 is positioned inside of the predetermined boundary 5 (e.g., the left and center of FIG. 3), then the controller may instruct the article contacting device 300 corresponding to the pocket 2 holding the pellet-shaped article having the seam 4 positioned inside of the predetermined boundary 5 to contact that pellet-shaped article 3 while passing that article contacting device 300. The article contacting device 300 may contact the corresponding pellet-shaped article 3 by the actuator 301 extending the finger 302 so that the contacting portion 303 contacts the corresponding pellet-shaped article 3 while positioned in its pocket 2 as it passes the article contacting device 300. Since the circumference of the pellet-shaped articles 3 is known and the conveyer 30 may operate at a known speed, the actuator 301 may extend the finger 302 so that the contacting portion 303 contacts the pellet-shaped article 3 for a duration sufficient to rotate the pellet-shaped article 3 90° or one-fourth of its circumference, for example. Once the pellet-shaped articles 3 with their seam 4 inside of the predetermined boundary 5 are contacted by the respective article contacting devices 300, the seams 4 are then all moved outside of the predetermined boundary 5 so that the processing unit 400 can apply indicia to the pellet-shaped articles 3 without contacting, and possibly damaging, seams 4.

For those pellet-shaped articles 3 with their seam 4 positioned outside of the predetermined boundary 5 at the inspection unit 200, the controller may determine not to send a signal to the corresponding article contacting device 300 to contact that pellet-shaped article 3. Thus, the pellet-shaped articles 3 having their seam 4 positioned outside of the predetermined boundary 5 may be allowed to pass the corresponding article contacting device 300 without contact. In the case of FIGS. 3 and 4, the pellet-shaped article 3 on the right has its seam 4 already outside of the predetermined boundary 5 in FIG. 3, and therefore it is allowed to remain in that position in FIG. 4.

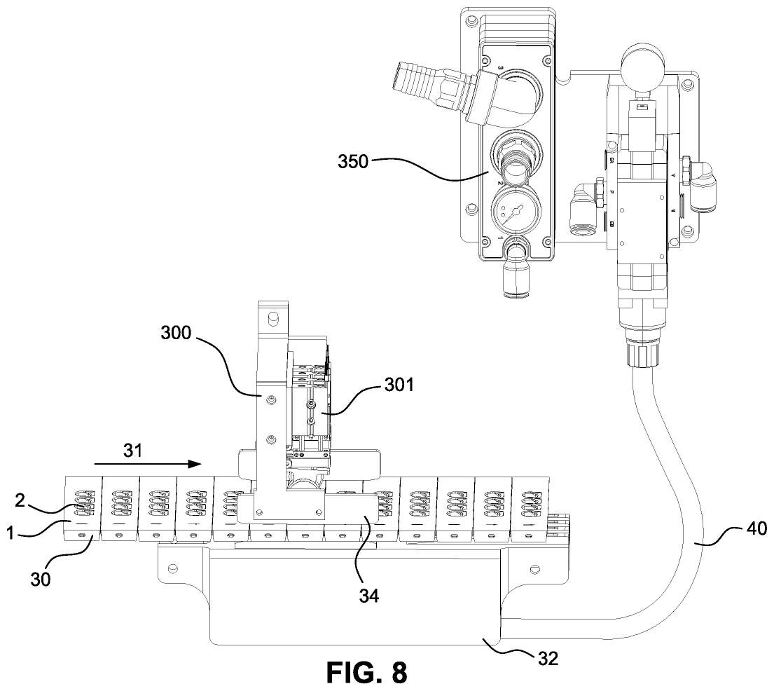

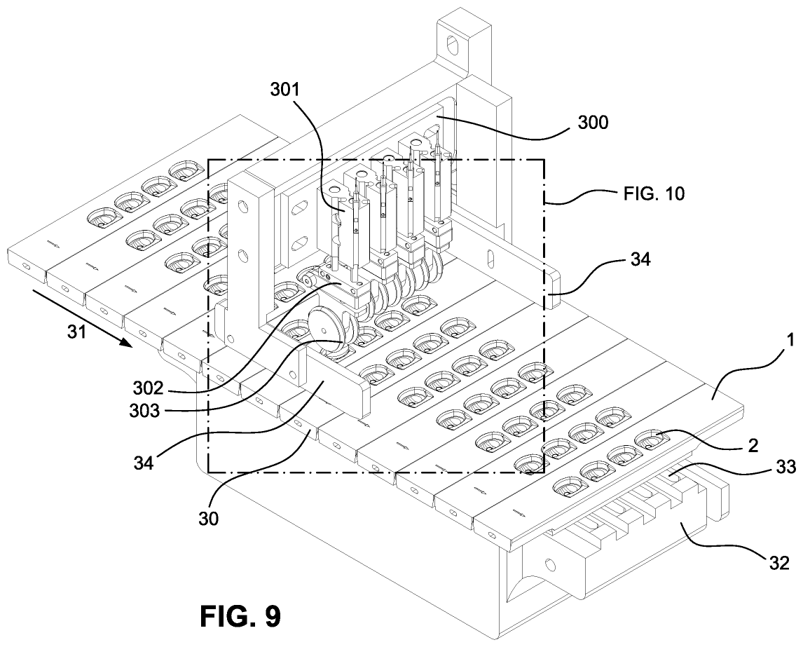

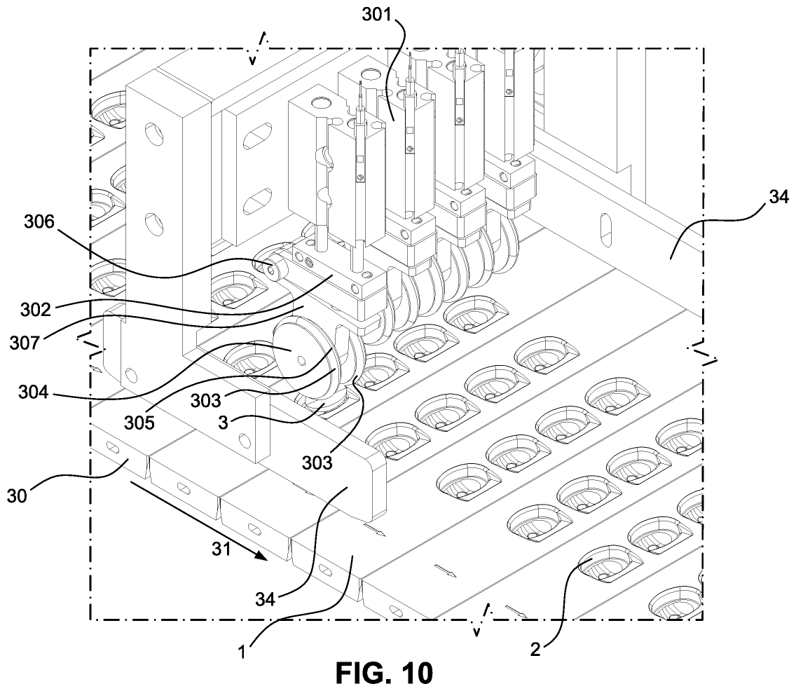

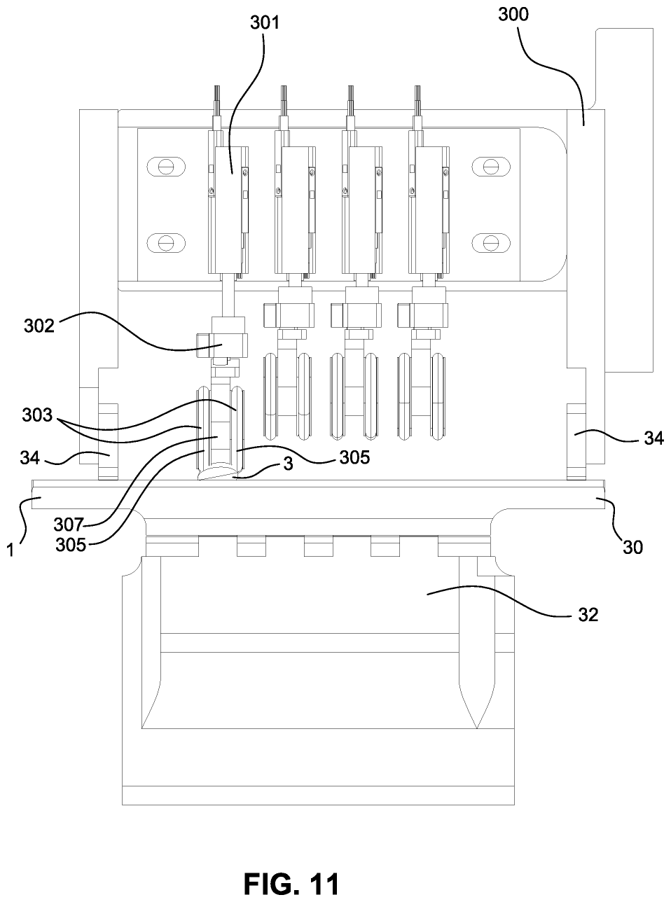

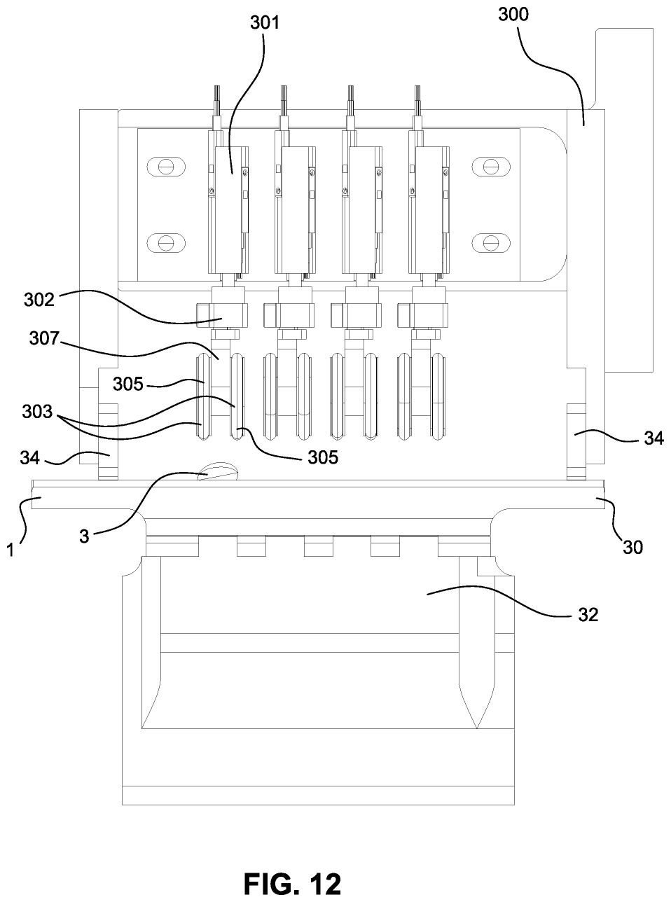

FIGS. 8-12 show a further example of the article contacting device 300, along with carrier bars 1 passing thereby. In this example, one or more actuators 301 are positioned above the conveyer 30. Each actuator 301 may operate the finger 302 in a vertical direction in response to instructions from the controller. The finger 302 may be movably (e.g., pivotably) connected to the contacting portion 303 by a pivot pin 306 and may be biased downwards by a spring (e.g., a coil spring) that is not shown.

The contacting portion 303 may include two wheels 304, each with an O-ring 305 around it. The wheels 304 may be fixed, i.e., do not rotate, to a base 307 of the contacting portion 303. In the depicted example, two wheels 304 are oriented in parallel with a gap therebetween on the contacting portion 303 and positioned to provide even contact to the pellet-shaped articles 3. Thus, when one of the contacting portions 303 is directed downwards by the actuator 301 the contact with the pellet-shaped article 3 is approximately symmetrical so as to ensure that the pellet-shaped article 3 is rotated about its longitudinal axis and not tilted in the pocket 2.

The O-rings 305 of each contacting portion 303 may be rubber to provide friction upon contact with the corresponding pellet-shaped article 3. Upon contact with the pellet-shaped article 3, the friction against the O-rings 305 will cause the pellet-shaped article 3 to rotate as the conveyer 30 transports the pellet-shaped article 3 past the article contacting device 300. The timing of the contact, i.e., the duration that the actuator 301 is in the downward position, may be calculated by factoring in the speed of the carrier bars 1 along the conveyer path 31 and the circumference of the pellet-shaped articles 3 so that the any pellet-shaped articles 3 that are contacted are rotated 90° to ensure the seam 4 is moved out of the boundary 5. Also, the spring bias between the finger 302 and the contacting portion 303 may allow the contacting portion 303 to rise slightly over the uppermost portion of the pellet-shaped article 3 as it passes by so as to avoid damaging the pellet-shaped article 3.

To further ease rotation of the pellet-shaped articles 3 in their respective pockets 2, when desired, each of the pockets 2 may be shaped and dimensioned to allow the pellet-shaped article 3 held therein to rotate when contacted by the corresponding article contacting device 300. The pockets 2 may be shallower than the diameter of the pellet-shaped articles 3 so that portion, e.g., 25%, 30%, or 40% of their circumference, extends out of the pockets 2 to allow the contacting portions 303 to contact the pellet-shaped articles 3 as they pass by without needing to extend into the pockets 2 to contact and rotate the pellet-shaped articles 3 the desired amount. In further examples, each of the carrier bars 1 may be coated, at least inside each of the pockets 2, with a substance to reduce friction with the pellet-shaped articles 3 to allow for easier rotation. In still further examples, the pockets 2 or the entire carrier bars 1 may be formed from a material that reduces friction with the pellet-shaped articles 3.

The conveyer apparatus 10 may include one or more pairs of the inspection unit 200 and the article contacting device 300. The inspection unit 200 and the article contacting device 300 of each pair may be arranged in sequence. While one pair of the inspection unit 200 and the article contacting device 300 may be sufficient to ensure all or nearly all of the pellet-shaped articles 3 are rotated into the proper orientation for the processing unit 400, a second pair of the inspection unit 200 and the article contacting device 300 may be included after the first pair along the conveyer path 31 to rotate into the proper orientation any of the pellet-shaped articles 3 that were not rotated into the proper orientation by the first pair of the inspection unit 200 and the article contacting device 300. Thus, although FIG. 4 shows the pellet-shaped articles 3 all with their seam 4 outside of the predetermined boundary 5, if that were not the case the second article contacting device 300 that follows the second inspection unit 200 could act on any pellet-shaped articles 3 still out of position.

During rotation of the pellet-shaped articles 3 by the article contacting devices 300, a vacuum may also be drawn against the underside of the pellet-shaped articles 3 during contact by the contacting portion 303. The hole 9 through the carrier bar 1 into each pocket 2 allows the vacuum created by a vacuum generator 350, drawn through a hose 40, and through a conveyer base 32 with vacuum slots 33 to act on the pellet-shaped articles 3. The vacuum may hold the pellet-shaped articles 3 in position and prevent over-rotation of the pellet-shaped articles 3 during contact with the contacting portion 303.

Also, upper chain guides 34 may be positioned above and in contact with the carrier bars 1 as they pass the article contacting device 300. The upper chain guides 34 may inhibit upward motion of the carrier bars 1 during transport so as to ensure that the pellet-shaped articles 3 are at a consistent height for contact with the contacting portions 303.

### D. Further Processing/Inspection of Pellet-Shaped Articles

After passing the article contacting devices 300, the pellet-shaped articles 3 may then be processed by the processing unit 400, e.g., by having a mark or indicia applied thereto by a printer or a laser. The mark or indicia may include hole(s), logo(s), alphanumeric character(s), etc.

Once processed, the pellet-shaped articles 3 may pass another inspection unit 250, e.g., to verify that the mark or indicia was not applied to the seam 4 of each of the pellet-shaped articles 3. The inspection unit 250 may acquire another image of each of the pellet-shaped articles 3 after processing and transmit to the controller. The inspection unit 250 may include a camera (e.g., CCD or CMOS) and/or a near-infrared (NIR) sensor. The controller may then determine, based on the image, whether the seam 4 and the indicia of each of the pellet-shaped articles 3 is inside or outside of the predetermined boundary 5. The inspection unit 250 may be similar to the inspection unit 200 in that it uses UV light to illuminate the pellet-shaped articles 3 so that the seam 4 can be detected to confirm whether or not the mark or indicia was applied to each of the pellet-shaped articles 3.

An ejection system 500 may then direct each of the pellet-shaped articles 3 into an accept bin 600 or a reject bin 601 based on the determination by the controller. If the seam 4 and the indicia of any one of the pellet-shaped articles 3 are both positioned inside of the predetermined boundary 5, that may indicate that the corresponding article contacting device 300 failed to adequately rotate that pellet-shaped article 3 before processing such that the seam 4 may have been damaged during processing. If such a determination is made by the controller, then the controller may instruct the ejection system 500 to direct the corresponding pellet-shaped article 3 into the reject bin 601 to avoid contamination of the apparatus 10 or other pellet-shaped articles 3 if a rupture occurs. If the seam 4 of any one of the pellet-shaped articles is positioned outside of the predetermined boundary 5 and the indicia of any one of the pellet-shaped articles 3 is positioned inside of the predetermined boundary 5, as determined by the controller, then the controller may instruct the ejection system 500 to direct the corresponding pellet-shaped article 3 into the accept bin 600.

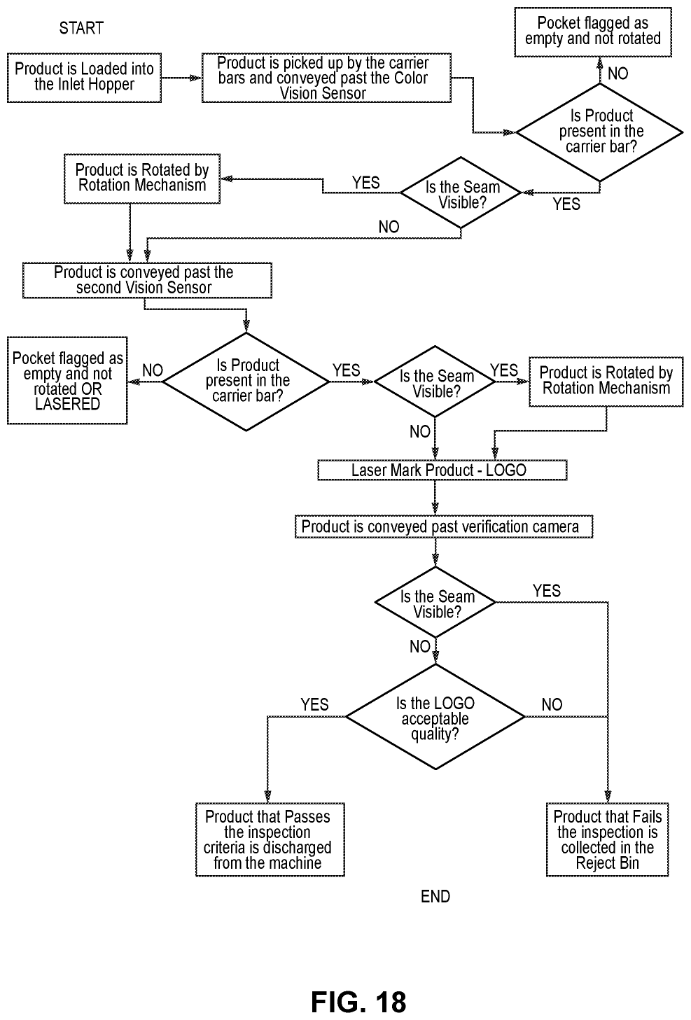

FIG. 18 depicts a flow chart of an example of a method according to the present technology. The various steps of this method are described above, and this flow chart shows how they can be consolidated into a method for inspecting and processing pellet-shaped articles 3. In addition to checking the pellet-shaped articles 3 for seam 4 location and defects, the method may also check whether each pocket 2 took up one of the pellet-shaped articles 3 from the hopper 100. If a given pocket 2 is identified as empty, no further operations (rotation, marking, etc.) are made with respect to that pocket 2.

While the technology has been described in connection with what is presently considered to be the most practical and preferred examples, it is to be understood that the technology is not to be limited to the disclosed examples, but on the contrary, is intended to cover various modifications and equivalent arrangements included within the spirit and scope of the appended claims.

### VII. REFERENCE SIGNS LIST

| | |
|---|---|
| carrier bar | 1 |
| pocket | 2 |
| pellet - shaped article | 3 |
| seam | 4 |
| predetermined boundary | 5 |
| bolt | 6 |
| base | 7 |
| pocket insert | 8 |
| hole | 9 |
| conveyer apparatus | 10 |
| internally threaded | 11 |
| receiving members | |
| through hole | 12 |
| bolt head | 13 |
| user interface | 20 |
| conveyer | 30 |
| conveyer path | 31 |
| conveyer base | 32 |
| vacuum slot | 33 |
| upper chain guide | 34 |
| hose | 40 |
| hopper | 100 |
| inspection unit | 200 |
| light source | 201 |
| light source mount | 202 |
| camera | 210 |
| filter | 211 |
| camera mount | 212 |
| inspection unit | 250 |
| article contacting device | 300 |
| actuator | 301 |
| finger | 302 |
| contacting portion | 303 |
| wheel | 304 |
| O-ring | 305 |
| pivot pin | 306 |
| base | 307 |
| vacuum generator | 350 |
| processing unit | 400 |
| ejection system | 500 |
| accept bin | 600 |
| reject bin | 601 |

1. An apparatus for processing pellet-shaped articles, each of the pellet-shaped articles having a seam around its perimeter, the apparatus comprising:
a conveyer comprising a plurality of carrier bars, each of the carrier bars having a plurality of pockets arranged in a row that is oriented perpendicularly to a direction of travel of the carrier bars along a conveyer path, each of the pockets being configured to receive one of the pellet-shaped articles;
an inspection unit configured to acquire an image of each of the pellet-shaped articles;
a plurality of article contacting devices positioned downstream of the inspection unit along the conveyer path and arranged in a row that is oriented perpendicularly to the direction of travel of the carrier bars, a number of article contacting devices being equal to a number of pockets in each of the carrier bars, and each of the article contacting devices being configured to contact a corresponding one of the pellet-shaped articles passing thereby along the conveyer path while being held in a corresponding pocket;
a processing unit positioned downstream of the plurality of article contacting devices and configured to mark each of the pellet-shaped articles with indicia; and
a controller configured to:
receive the image of each of the pellet-shaped articles acquired by the inspection unit;
determine, based on the image, whether the seam of each of the pellet-shaped articles is positioned inside or outside of a predetermined boundary; and
responsive to the determination, instruct the article contacting device whether to manipulate the pellet-shaped article.

2. The apparatus of claim 1, wherein the controller is configured to instruct the article contacting device corresponding to the pocket holding the pellet-shaped article having the seam positioned inside of the predetermined boundary to contact that pellet-shaped article while passing that article contacting device, if the seam of any one of the pellet-shaped articles is determined to be positioned inside of the predetermined boundary.

3. The apparatus of claim 1, wherein the controller is configured to allow the pellet-shaped article having the seam positioned outside of the predetermined boundary to pass the corresponding article contacting device without contact, if the seam of any one of the pellet-shaped articles is determined to be positioned outside of the predetermined boundary.

4. The apparatus of claim 1, wherein each of the article contacting devices comprises an actuator and a finger connected to the actuator.

5. The apparatus of claim 4, wherein the finger of each of the article contacting devices comprises a contacting portion configured to contact each of the pellet-shaped articles.

6. The apparatus of claim 5, wherein the contacting portion comprises a flexible material.

7. The apparatus of claim 6, wherein the flexible material is rubber.

8. The apparatus of claim 5, wherein the contacting portion is a rubber O-ring.

9. The apparatus of claim 5, wherein the finger has an elongate shape, a first end of the finger being connected to the actuator and the contacting portion being positioned on a second end of the finger.

10. The apparatus of claim 4, wherein the actuator is configured to move the finger towards and away from the conveyer along a longitudinal axis of the finger.

11. The apparatus of claim 4, wherein the actuator is a solenoid.

12. The apparatus of claim 4, wherein the actuator is pneumatically operated.

13. The apparatus of claim 5, wherein each of the article contacting devices comprises a spring to attenuate motion of the finger when the contacting portion contacts a corresponding pellet-shaped article.

14. The apparatus of claim 1, wherein each of the article contacting devices is configured to contact, when instructed by the controller, a corresponding pellet-shaped article for a duration sufficient to rotate the pellet-shaped article approximately 90° within the corresponding pocket.

15. The apparatus of claim 1, wherein each of the pockets is shaped and dimensioned to allow the pellet-shaped article held therein to rotate when contacted by the corresponding article contacting device.

16. The apparatus of claim 1, wherein each of the carrier bars is coated, at least inside each of the pockets, with a substance to reduce friction with the corresponding pellet-shaped article.

17. The apparatus of claim 1, wherein at least the pockets of each of the carrier bars is formed from a material that reduces friction with the corresponding pellet-shaped article.

18. The apparatus of claim 1, wherein the processing unit comprises at least one of a laser and a printer.

19. The apparatus of claim 1, wherein the inspection unit comprises a camera or a near-infrared (NIR) sensor.

20. The apparatus of claim 1, further comprising:
an additional inspection unit positioned downstream of the processing unit and configured to acquire an additional image of each of the pellet-shaped articles after processing; and
an ejection system configured to direct each of the pellet-shaped articles into an accept bin or a reject bin.

21. The apparatus of claim 20, wherein the controller is configured to:
receive the additional image of each of the pellet-shaped articles acquired by the additional inspection unit;
determine, based on the image, whether the seam and the indicia of each of the pellet-shaped articles is inside or outside of the predetermined boundary;
if the seam and the indicia of any one of the pellet-shaped articles are positioned inside of the predetermined boundary, then instruct the ejection system to direct the corresponding pellet-shaped article into the reject bin; and
if the seam of any one of the pellet-shaped articles is positioned outside of the predetermined boundary and the indicia of any one of the pellet-shaped articles is positioned inside of the predetermined boundary, then instruct the ejection system to direct the corresponding pellet-shaped article into the accept bin.

22. A system for inspecting and processing pellet-shaped articles, the system comprising:
a conveyer including a plurality of carrier bars configured to transport pellet-shaped articles along a conveyer path, each of the carrier bars having one or more pockets, and each of the pockets being shaped and dimensioned to receive one pellet-shaped article;
one or more inspection apparatuses, the conveyer being configured to transport the pellet-shaped articles past the inspection apparatus, the inspection apparatus including:
a light source configured to illuminate the pellet-shaped articles with light while passing the inspection apparatus;
a camera configured to capture an image of each of the pellet-shaped articles while passing the inspection apparatus; and
a filter configured to restrict transmission of light having a wavelength approximately equal to the light from the light source, the filter being positioned between the pellet-shaped articles passing through the inspection apparatus and the camera such that light having a wavelength approximately equal to the light from the light source is prevented from reaching the camera;
one or more processing apparatuses configured to perform one or more processing operations on the pellet-shaped articles; and
a controller configured to receive images of the pellet-shaped articles captured by the camera and configured to instruct the one or more processing apparatuses to perform the one or more processing operations.

23. The system of claim 22, wherein light from the light source is UV light.

24. The system of claim 22, wherein light from the light source has a wavelength centered at a wavelength in the range of approximately 300 nm to approximately 800 nm.

25. The system of claim 22, wherein light from the light source has a wavelength centered at approximately 365 nm.

26. The system of claim 22, wherein the filter is configured to transmit only visible light.

27. The system of claim 22, wherein the filter is configured to transmit only light having a wavelength within a portion of the visible light spectrum.

28. The system of claim 22, wherein the filter is an absorption filter.

29. The system of claim 22, wherein the controller is configured to detect one or more characteristics of each of the pellet-shaped articles from each image received from the camera.

30. The system of claim 29, wherein the pellet-shaped articles are softgel capsules and the characteristic is a seam each of the softgel capsules.

31. The system of claim 22, wherein a hole extends from each pocket through each of the carrier bars.

32. The system of claim 22, wherein each of the carrier bars includes a number of holes equal to a number of pockets.

33. The system of claim 31, wherein the hole extends from a bottom surface of pocket.

34. The system of claim 22, further comprising a vacuum generator pneumatically connected to a conveyer base to draw a vacuum through each hole in the carrier bars passing over the conveyer base.

35. The system of claim 31, wherein the carrier bars comprise a base constructed from a first material and a pocket insert constructed from a second material that is different from the first material.

36. The system of claim 22, wherein the pockets are formed in the pocket insert.

37. The system of claim 35, wherein the first material is more rigid than the second material.

38. The system of claim 35, wherein the first material is metal and the second material is plastic.

39. The system of claim 38, wherein the metal is aluminum.

40. The system of claim 35, wherein the hole extends through the first material and the second material.

41. The system of claim 35, wherein the pocket insert is removable from the base.

42. The system of claim 22, comprising:
a first inspection apparatus and a second inspection apparatus; and
a first processing apparatus positioned downstream of the first inspection apparatus and upstream of the second inspection apparatus relative to the conveyer path and a second processing apparatus downstream of the second inspection apparatus relative to the conveyer path.

43. The system of claim 22, wherein the processing apparatus comprises an article contacting device positioned above each row of pockets of the carrier bars, the article contacting device being configured to contact individual pellet-shaped articles in response to instructions from the controller to rotate individual pellet-shaped articles within respective pockets.

44. The system of claim 22, wherein each article contacting device comprises an actuator, a finger configured to driven by the actuator, and a contacting portion movably connected to the finger, the contacting portion configured to contact individual pellet-shaped articles in corresponding pockets.

45. The system of claim 44, wherein the contacting portion comprises a base having one or more wheels immovably fixed thereto and an O-ring positioned around each wheel to contact pellet-shaped articles.

46. The system of claim 45, wherein the article contacting device comprises a pivot pin that pivotably connects the finger to the base of the contacting portion and a spring positioned between the finger and the base to bias the contacting portion.

47. The system of claim 22, further comprising a processing unit configured to apply a mark to each of the pellet-shaped articles.
